(19) United States
(12) Patent Application Publication
(10) Pub. No.: US 2026/0203165 A1
(43) Pub. Date: Jul. 16, 2026

(54) SUB-CHANNEL SWITCHING USING REDUNDANT PINS

(71) Applicant: Micron Technology, Inc., Boise, ID (US)

(72) Inventor: Scott E. Schaefer, Boise, ID (US)

(21) Appl. No.: 19/437,819

(22) Filed: Dec. 31, 2025

Related U.S. Application Data
(60) Provisional application No. 63/745,691, filed on Jan. 15, 2025.

(51) Int. Cl. G06F 11/10

(52) U.S. Cl. CPC G06F 11/1048; G06F 11/1016

(57) ABSTRACT

Methods, systems, and devices for sub-channel switching using redundant pins are described. The described techniques may enable a host system to switch from communicating with a memory system via a first set of pins associated with a first sub-channel to communicating with the memory system via a second set of pins associated with a second sub-channel based on detecting a fault associated with the first set of pins. In some examples, the host system may communicate via both the first set of pins and the second set of pins. The memory system may perform a comparison between data received via the first set of pins and the second set of pins, and may indicate to the host system if a difference is detected. The host system may switch to communicating via one of the first set of pins or the second set of pins based on detecting the difference.

### CROSS REFERENCE

The present Application for Patent claims priority to U.S. Patent Application No. 63/745,691 by Schaefer et al., entitled “SUB-CHANNEL SWITCHING USING REDUNDANT PINS,” filed January 15, 2025, which is assigned to the assignee hereof, and which is expressly incorporated by reference in its entirety herein.

### TECHNICAL FIELD

The following relates to one or more systems for memory, including sub-channel switching using redundant pins.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports sub-channel switching using redundant pins in accordance with examples as disclosed herein.

FIG. 2 shows an example of a system that supports sub-channel switching using redundant pins in accordance with examples as disclosed herein.

FIG. 3 shows an example of a system that supports sub-channel switching using redundant pins in accordance with examples as disclosed herein.

FIG. 4 shows an example of a system that supports sub-channel switching using redundant pins in accordance with examples as disclosed herein.

FIG. 5 shows an example of a process flow that supports sub-channel switching using redundant pins in accordance with examples as disclosed herein.

FIG. 6 shows a block diagram of a memory system that supports sub-channel switching using redundant pins in accordance with examples as disclosed herein.

FIG. 7 shows a block diagram of a host system that supports sub-channel switching using redundant pins in accordance with examples as disclosed herein.

FIGS. 8 and 9 show flowcharts illustrating a method or methods that support sub-channel switching using redundant pins in accordance with examples as disclosed herein.

### DETAILED DESCRIPTION

A memory system may include or otherwise be coupled with one or more pins, such as one or more sets of pins configured to support communications with a host system. Each set of pins may be associated with one or more sub-channels between the memory system and the host system. Each sub-channel may include or otherwise be coupled with one or more components of the memory system (e.g., the corresponding sets of pins, one or more buffers, one or more address decoders or other logic, one or more amplifiers, and the like) that may facilitate communications with one or more components of the host system (e.g., a physical interface or physical layer of the host system) via the respective sub-channel. In some examples, the memory system may communicate via two sub-channels simultaneously, or may communicate via a first sub-channel while one or more components of a second sub-channel are in a power saving mode (e.g., deep sleep shutdown). However, one or more pins associated with the first sub-channel may experience a fault during operation, which may result in relatively reduced performance of the memory system as a result of a lower quality of communication with the host system via the corresponding first sub-channel.

Accordingly, techniques described herein may enable a host system to dynamically switch, during operations, from communicating with a memory system via a first set of pins (e.g., associated with a first sub-channel) to communicating with the memory system via a second set of pins (e.g., associated with a second sub-channel) based on detecting a fault associated with the first set of pins. A set of pins as discussed herein may include one or more pins, including one or more data pins, one or more command/address (C/A) pins, or any combination thereof configured to communicate data, commands, control information, or the like via one or more associated channels or interfaces. The host system may communicate with the memory system via the second set of pins using a same physical interface (e.g., physical layer, PHY), or may switch to a second physical interface associated with the second sub-channel. The fault may be detected by some quantity of errors within a duration exceeding a threshold (e.g., thereby satisfying a threshold error condition), by some metadata or other indication, or both. In some examples, the host system may communicate via both the first set of pins and the second set of pins. In such examples, the memory system may perform a comparison between data received via the first set of pins and the second set of pins, and may indicate to the host system if a difference between the data is detected. The fault may be based on the indication of the difference between the data. The host system may indicate for the memory system to switch to communicating via one of the first set of pins or the second set of pins based on the difference.

In addition to applicability in memory systems as described herein, techniques for subchannel switching may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by including redundant pins, which may reduce a quantity of errors in communications between host systems and memory systems while supporting reduced or otherwise low-power operational modes, among other benefits.

In addition to applicability in memory systems as described herein, techniques for subchannel switching may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by including redundant pins, which may reduce electronic waste and extend the life of electronic devices, among other benefits.

Features of the disclosure are illustrated and described in the context of systems and architectures. Features of the disclosure are further illustrated and described in the context of process flows and flowcharts.

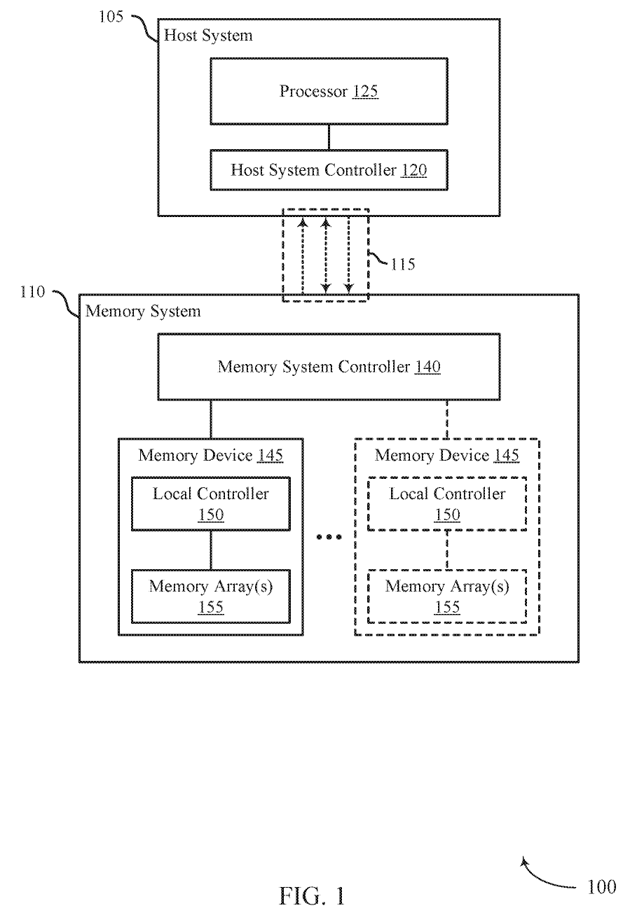

FIG. 1 shows an example of a system 100 that supports sub-channel switching using redundant pins in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a

host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

In some examples of the system 100, a host system 105 may switch from communicating with a memory system 110 via a first set of pins associated with a first sub- channel to communicating with the memory system 110 via a second set of pins associated with a second sub-channel based on detecting a fault associated with the first set of pins. The first sub-channel and the second sub-channel may be included in the one or more channels 115 illustrated in FIG. 1. The host system 105 may communicate with the memory system 110 via the second set of pins using a same physical interface (e.g., physical layer), or may switch to a second physical interface associated with the second sub-channel. In some examples, the host system 105 may communicate via both the first set of pins and the second set of pins. In such examples, the memory system 110 may perform a comparison between data received via the first set of pins and the second set of pins, and may indicate to the host system 105 if a difference between the data is detected. The host system 105 may indicate for the memory system 110 to switch to communicating via one of the first set of pins or the second set of pins based on detecting the difference.

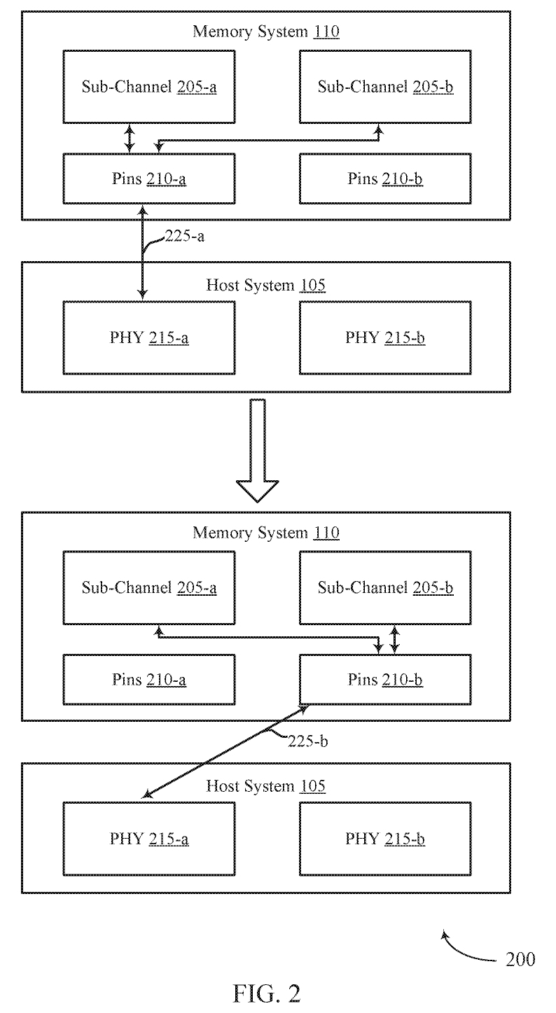

FIG. 2 shows an example of a system 200 that supports sub-channel switching using redundant pins in accordance with examples as disclosed herein. The system 200 may implement or may be implemented by aspects of the system 100. For example, the system 200 may be implemented by memory system 110 and a host system 105, which may be examples of the corresponding devices as described with reference to FIG. 1.

In some examples, one or more components of a memory system 110 (e.g., a DRAM device) may include multiple sub-channels 205. For example, the memory system 110 may include a sub-channel 205-a associated with a set of pins 210-a and a sub-channel 205-b associated with a set of pins 210-b. The pins 210-a and the pins 210-b may include CA pins and/or DQ pins as described herein. The CA pins may be configured to convey information associated with one or more commands and addresses of the associated data, which may be conveyed via the DQ pins. In some examples, the pins 210-a may be upper CA/DQ pins and the pins 210-b may be lower CA/DQ pins (e.g., or vice-versa). Each sub-channel 205 may include clock and control inputs (e.g., control input buffers, clock input buffers), CA inputs and decoders (e.g., CA input buffers, CA decoders), refresh logic, redundancy fuses and logic, mode registers, test mode logic, column and row address decoders, sub-word drivers, arrays (e.g., bit arrays, sense amplifiers), input/output (I/O) logic (e.g., data I/O control logic), I/O busses, error correction control (ECC) blocks, write clock (WCK) input buffers, or any combination thereof. The memory system 110 may include internal power and reference supplies (e.g., analog supplies) that may provide power to each sub-channel 205. In some examples, each sub-channel 205 may include a quantity of memory banks (e.g., 16 banks) that may include rows and columns of storage units. As described herein, a sub-channel 205 may represent an example of the circuitry, logic, and memory within the memory system 110 configured to facilitate communications with an external device, such as the host system 105, via a respective set of pins 210.

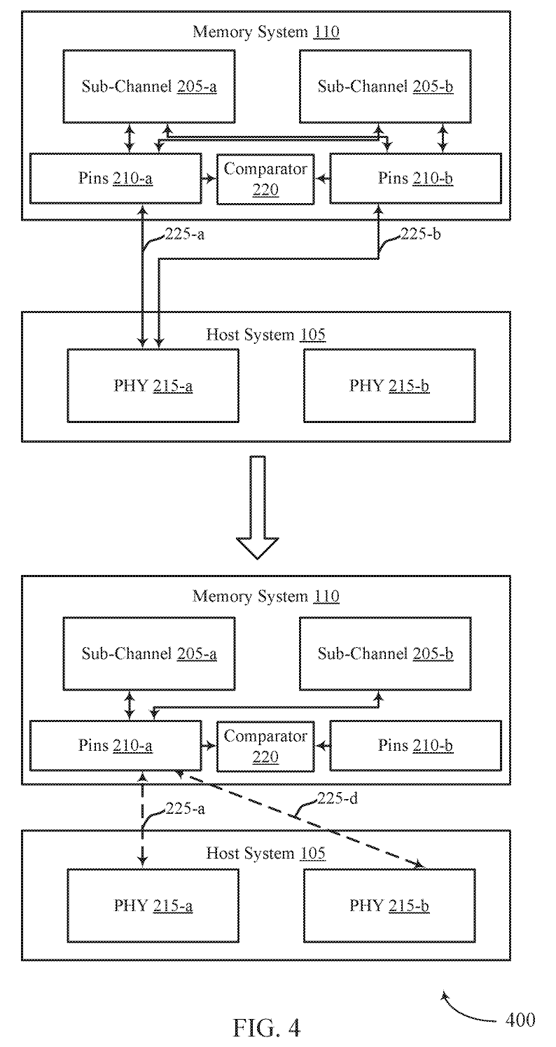

In some examples, the memory system 110 and the host system 105 may operate according to an efficiency mode (e.g., a power saving mode) in which one or more components of the memory system 110 and the host system 105 may enter a power saving mode (e.g., deep sleep shutdown). For example, when the memory system 110 enters the power saving mode, a set of pins 210 of the memory system 110 may be disabled or otherwise idle (e.g., not used for communication). Such techniques may increase power savings of the memory system 110 and the host system 105 (e.g., in exchange for a reduction in communication bandwidth between the memory system 110 and the host system 105, such as 12 data pins for I/O communications rather than 24 data pins). Accordingly, the memory system 110 and the host system 105 may communicate via one set of pins 210 at a time while in the power saving mode. Additionally, or alternatively, the memory system 110 and the host system 105 may communicate via both of the pins 210-a and the pins 210-b (e.g., a permanently in mode to obtain double density of communication bandwidth, as described and illustrated with reference to FIG. 4).

In some examples, one or more pins of the pins 210-a and/or the pins 210-b may experience a fault (e.g., a hardware failure, a software failure, or some other type of failure that negatively impacts performance and operability of the pins), which may decrease a quality of communications between the host system 105 and the memory system 110. Accordingly, techniques described herein may enable the host system 105 to indicate which pins 210 for the memory system 110 to use for communications. For example, the host system 105 may indicate for the memory system 110 to switch from communicating with the host system 105 via the pins 210-a to communicating with the host system 105 via the pins 210-b (e.g., and refraining from communicating with the host system 105 via the pins 210-a). The described techniques for dynamic pin and sub-channel switching may thereby provide for the memory system 110 to maintain the power savings associated with communicating via a single set of pins 210 at a time, while improving throughput and reliability when faults occur, for example.

As illustrated with reference to FIG. 2, the host system 105 (e.g., a host system controller 120 of the host system 105) may communicate with the memory system 110 via a channel 225-a between the pins 210-a and a physical layer (PHY) 215-a of the host system 105. As described herein, a channel 225 may refer to an interface between a set of pins 210 at the memory system 110 and an external device (e.g., a PHY 215 at the host system 105). For example, the host system 105 may communicate data with one or both of the sub-channel 205-a and the sub-channel 205-b (e.g., in an interleaved manner) via the pins 210-a. In some examples, a PHY 215-b of the host system 105 and/or the pins 210-b may be disabled or otherwise idle in a power saving mode (e.g., deep sleep shutdown).

In some examples, the host system 105 may detect a fault (e.g., a short circuit, an open circuit) associated with the pins 210-a based on satisfaction of a threshold error condition. For example, the host system 105 may detect a threshold quantity of errors in data communicated from the memory system 110 via the set of pins 210-a, or may detect errors for a threshold amount of time or instances of data communicated via the set of pins 210-a, or both. The host system 105 may determine that the errors are indicative of a fault in the pins 210-a (e.g., based on one or more threshold quantities or durations). The host system 105 may accordingly indicate, to the memory system 110, to switch from communicating via the pins 210-a to communicating via the pins 210-b. For example, the host system 105 may adjust a value of a mode register (MR) of the memory system 110 from a first value that indicates for the memory system 110 to communicate via the pins 210-a to a second value that indicates for the memory system 110 to communicate via the pins 210-b. The MR value may include one or more bits configured to indicate the pin setting. The memory system 110 may disable the set of pins 210-a in response to the indication from the host system 105. The host system 105 may accordingly communicate with the sub-channel 205-a and the sub-channel 205-b of the memory system 110 via a channel 225-b (e.g., an interface) between the PHY 215-a and the pins 210-b, which may increase a quality of communication (e.g., due to communicating via pins 210-b that may not include a fault). That is, the host system 105 may maintain the PHY 215-b in an idle or deep-sleep shutdown state to reduce power consumption, and may continue communications via an interface between the PHY 215-a and the set of pins 210-b. The data from one or more memory arrays associated with the sub-channel 205-a may be interleaved with data from one or more memory arrays associated with the sub-channel 205-b via the interface, in some examples.

In some implementations, one or more components of the host system 105 and the memory system 110 may enter the power saving mode in response to switching from the pins 210-a to the pins 210-b. For example, the pins 210-a may enter a deep sleep shutdown, which may decrease power consumption in the system 200. Additionally, or alternatively, the memory system 110 and the host system 105 and components thereof may maintain operations in the power saving mode. For example, the memory system 110 and the host system 105 may continue to communicate via a single set of pins 210 with reduced power as compared with communications via more than one set of pins 210, but which set of pins 210 is used may be different to improve throughput and reliability.

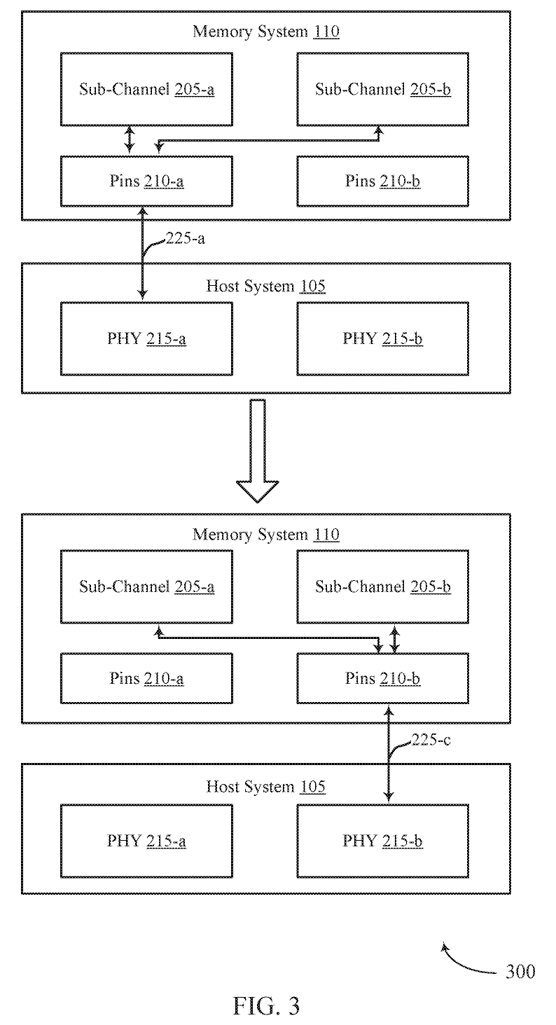

FIG. 3 shows an example of a system 300 that supports sub-channel switching using redundant pins in accordance with examples as disclosed herein. The system 300 may implement or may be implemented by aspects of the system 100 and the system 200. For example, the system 300 may be implemented by memory system 110 and a host system 105, which may be examples of the corresponding devices as described with reference to FIG. 1. The devices of the system 300 may include pins 210, PHYs 215, and sub-channels 205, which may be examples of the corresponding components as described herein with reference to FIG. 2.

As described with reference to FIG. 2, in some examples, a host system 105 (e.g., a host system controller 120 of the host system 105) may communicate with a memory system 110 via a channel 225-a between a set of pins 210-a and a PHY 215-a of the host system 105. For example, the host system 105 may communicate data with one or both of a sub-channel 205-a and a sub-channel 205-b of the memory system 110 (e.g., in an interleaved manner) via the pins 210-a. In some examples, a PHY 215-b of the host system 105 and/or the pins 210-b may be disabled or otherwise idle in a power saving mode (e.g., deep sleep shutdown).

In some examples, the host system 105 may detect a fault (e.g., a short circuit, an open circuit) associated with the pins 210-a based on satisfaction of a threshold error condition. For example, the host system 105 may detect a threshold quantity of errors in data communicated from the memory system 110 via the set of pins 210 a, or may detect errors for a threshold amount of time or instances of data communicated via the set of pins 210 a, or both. The host system 105 may determine that the errors are indicative of a fault in the pins 210-a (e.g., based on one or more threshold quantities or durations). The host system 105 may accordingly indicate, to the memory system 110, to switch from communicating via the pins 210-a to communicating via the pins 210-b. For example, the host system 105 may adjust a value of a MR of the memory system 110 from a first value that indicates for the memory system 110 to communicate via the pins 210-a to a second value that indicates for the memory system 110 to communicate via the pins 210-b. The MR value may include one or more bits configured to indicate the pin setting. The memory system 110 may disable the set of pins 210 a in response to the indication from the host system 105.

In some examples, the host system 105 may include a redundant PHY 215. For example, the host system 105 may include a PHY 215-b. In some examples (e.g., if the host system 105 detects a fault associated with the PHY 215-a), the host system 105 may communicate with the memory system 110 via the PHY 215-b. That is, the host system 105 may communicate with the sub-channel 205-a and the sub-channel 205-b of the memory system 110 via a channel 225-c (e.g., an interface between the PHY 215-b and the pins 210-b), which may increase a quality of communication (e.g., due to communicating via pins 210-b and a PHY 215-b that may not include a fault). That is, the host system 105 may transition the PHY 215-a to an idle or deep-sleep shutdown state to reduce power consumption, and may communications via an interface between the PHY 215-b and the pins 210-b. The data from one or more memory arrays associated with the sub-channel 205-a may be interleaved with data from one or more memory arrays associated with the sub-channel 205-b via the interface, in some examples.

In some examples, the host system 105 may switch to communicating via the channel 225-c between the PHY 215-b and the pins 210-b (e.g., and set the MR to the second value) in response to detecting a fault in either of the pins 210-a or the PHY 215-a. Additionally, or alternatively, the host system 105 may communicate with the memory system 110 via a channel 225-b between the PHY 215-a and the pins 210-b in response to detecting a fault associated with the pins 210-a (e.g., and not detecting a fault associated with the PHY 215-a), and/or may communicate with the memory system 110 via a channel 225-d between the PHY 215-b and the pins 210-a in response to detecting a fault associated with the PHY 215-a (e.g., and not detecting a fault associated with the pins 210-a). In such examples, the host system 105 may switch to communicating via the channel 225-c between the PHY 215-b and the pins 210-b (e.g., and set the MR to the second value) in response to detecting a fault in both of the pins 210-a or the PHY 215-a.

In some implementations, one or more components of the host system 105 and the memory system 110 may enter the power saving mode in response to switching from the pins 210-a to the pins 210-b and from the PHY 215-a to the PHY 215-b. For example, the pins 210-a and the PHY 215-a may enter a deep sleep shutdown, which may decrease power consumption in the system 300. Additionally, or alternatively, the memory system 110 and the host system 105 and components thereof may maintain operations in the power saving mode. For example, the memory system 110 and the host system 105 may continue to communicate via a single set of pins 210 with reduced power as compared with communications via more than one set of pins 210, but which set of pins 210 is used may be different to improve throughput and reliability.

FIG. 4 shows an example of a system 400 that supports sub-channel switching using redundant pins in accordance with examples as disclosed herein. The system 400 may implement or may be implemented by aspects of the system 100, the system 200, and the system 300. For example, the system 400 may be implemented by memory system 110 and a host system 105, which may be examples of the corresponding devices as described with reference to FIG. 1. The devices of the system 400 may include pins 210, PHYs 215, and sub-channels 205, which may be examples of the corresponding components as described herein with reference to FIG. 2.

In some examples, a host system 105 (e.g., a host system controller 120 of the host system 105) may communicate with a memory system 110 via a channel 225-a between pins 210-a and a PHY 215-a of the host system 105 and via a channel 225-b between pins 210-b and the PHY 215-a. For example, the host system 105 may communicate data with one or both of a sub-channel 205-a and a sub-channel 205-b of the memory system 110 (e.g., in an interleaved manner) via the pins 210-a and the pins 210-b. In some examples, a PHY 215-b of the host system 105 may be in a power saving mode (e.g., deep sleep shutdown).

In some examples, when the host system 105 communicates redundant (e.g., duplicative) data with two sub-channels 205-a and 205-b of the memory system 110, the memory system 110 may include a comparator 220 that may compare data communicated (e.g., received) via the pins 210-a and data communicated via the pins 210-b. The comparator 220 may include circuitry and/or logic configured to compare the data. The memory system 110 may therefore determine whether the data communicated via the pins 210-a is the same as the data communicated via the pins 210-b. In some examples, if the memory system 110

determines that the data communicated via the pins 210-a is not the same as the data communicated via the pins 210-b, the memory system 110 may indicate, to the host system 105, that a difference (e.g., a mismatch) is detected. Since the data is redundant (e.g., the same), the difference may be indicative of a fault in one or both of the sets of pins. In some examples, the memory system 110 may indicate, to the host system 105, which of the pins 210-a or the pins 210-b include the fault. Additionally, or alternatively, the host system 105 may determine which of the pins 210-a or the pins 210-b include the fault.

In some examples, the host system 105 may detect satisfaction of a threshold error condition, such as a threshold quantity of errors in data communicated from the memory system 110 via the pins 210-a or the pins 210-b, or may detect errors for a threshold amount of time or instances of data communicated, or both (e.g., based on receiving one or more indications of mismatches). The host system 105 may determine that the errors are indicative of a fault in the pins 210-a or the pins 210-b. The host system 105 may accordingly indicate, to the memory system 110, to switch from communicating via both of the pins 210-a and the pins 210-b to communicating via one of the pins 210-a or the pins 210-b. The MR value may include one or more bits configured to indicate the pin setting. For example, if the host system 105 determines that the pins 210-b include the fault, the host system 105 may adjust a value of a MR of the memory system 110 from a first value that indicates for the memory system 110 to communicate via both of the pins 210-a and the pins 210-b to a second value that indicates for the memory system 110 to communicate via the pins 210-a. The memory system 110 may disable the set of pins 210-b in response to the indication from the host system 105.

In some examples, the host system 105 may communicate with the memory system 110 via the channel 225-a between the PHY 215-a and the pins 210-a or via a channel 225-d (e.g., an interface between the pins 210-a and a PHY 215-b). For example, the host system 105 may include a redundant PHY 215 (e.g., the PHY 215-b). In examples in which the host system 105 detects a fault associated with the PHY 215-a, the host system 105 may communicate with the memory system 110 via the PHY 215-b. That is, the host system 105 may communicate with the sub-channel 205-a and the sub-channel 205-b of the memory system 110 via the third channel between the PHY 215-b and the pins 210-b, which may increase a quality of communication (e.g., due to communicating via pins 210-a and a PHY 215-b that may not include a fault).

In some examples, the host system 105 may switch to communicating via the channel 225-d between the PHY 215-b and the pins 210-a (e.g., and set the MR to the second value) in response to detecting a fault in either of the pins 210-b or the PHY 215-a. Additionally, or alternatively, the host system 105 may communicate with the memory system 110 via the channel 225-a between the PHY 215-a and the pins 210-a in response to detecting a fault associated with the pins 210-b (e.g., and not detecting a fault associated with the PHY 215-a), and/or may communicate with the memory system 110 via the channel 225-d between the PHY 215-b and the pins 210-a and a channel 225-c between the PHY 215-b and the pins 210-b in response to detecting a fault associated with the PHY 215-a (e.g., and not detecting a fault associated with the pins 210-a or the pins 210-b). In such examples, the host system 105 may switch to communicating via the channel 225-d between the PHY 215-b and the pins 210-a (e.g., and set the MR to the second value) in response to detecting a fault in both of the pins 210-b or the PHY 215-a.

In some implementations, one or more components of the host system 105 and the memory system 110 may enter the power saving mode in response to switching from communicating via both of the pins 210-a and the pins 210-b to communicating via the pins 210-a (e.g., and/or in response to switching from the PHY 215-a to the PHY 215-b). For example, the pins 210-b and the PHY 215-a may enter a deep sleep shutdown, which may decrease power consumption in the system 400. Additionally, or alternatively, the memory system 110 and the host system 105 and components thereof may maintain operations in the power saving mode. For example, the memory system 110 and the host system 105 may continue to communicate via a single set of pins 210 with reduced power as compared with communications via more than one set of pins 210, but which set of pins 210 is used may be different to improve throughput and reliability.

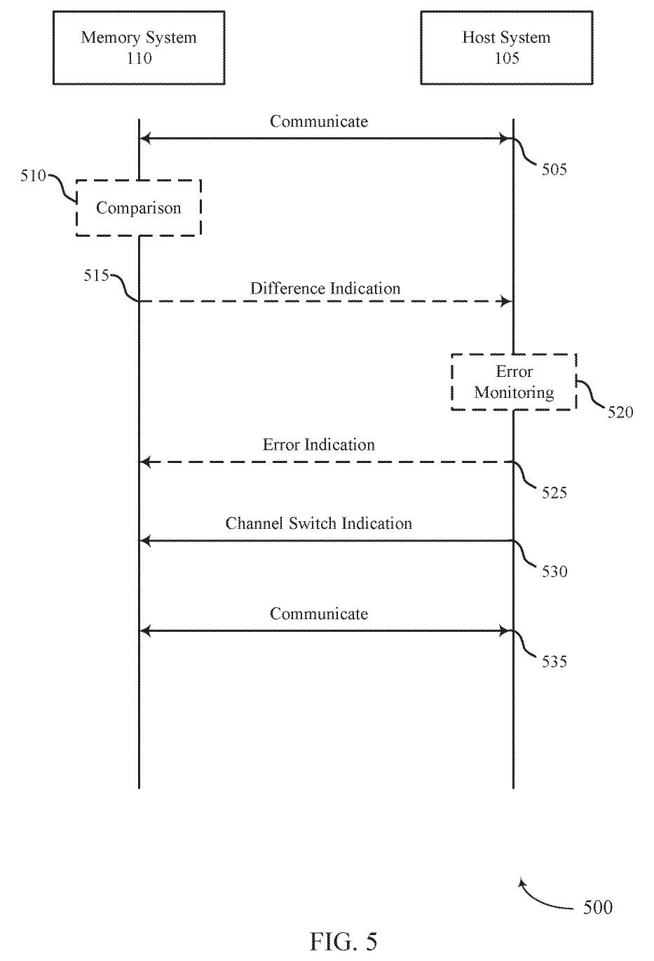

FIG. 5 shows an example of a process flow 500 that supports sub-channel switching using redundant pins in accordance with examples as disclosed herein. The process flow 500 may implement or may be implemented by aspects of the system 100, the system 200, the system 300, or the system 400. For example, the process flow 500 may be implemented by a memory system 110 and a host system 105, which may be examples of the corresponding devices as described with reference to FIG. 1. The devices of the process flow 500 may include pins 210, PHYs 215, and sub-channels 205, which may be examples of the corresponding components as described herein with reference to FIG. 2.

In the following description of the process flow 500, the operations between the memory system 110 and the host system 105 may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

At 505, the host system 105 and the memory system 110 may communicate data via a first channel between a first set of pins (e.g., CA pins, DQ pins) at the memory system 110 and a first physical interface (e.g., a first PHY) of the host system 105. For example, the host system 105 may output commands (e.g., read commands or write commands) to the memory system 110 via the first channel and the memory system 110 may output data to the host system 105 via the first channel (e.g., in accordance with one or more read commands). In some examples, the host system may communicate with one or more sub-channels of the memory system 110 (e.g., in an interleaved manner) via the first channel.

In some examples, the host system 105 may additionally communicate with the memory system 110 via a second channel between the host system 105 (e.g., the first PHY) and a second set of pins (e.g., CA pins, DQ pins) of the memory system 110. For example, the memory system may communicate with the memory system 110 via the first channel and the second channel in an interleaved manner. In such examples, at 510, the memory system 110 may perform a comparison between data communicated via the first channel (e.g., the first set of pins) and data communicated via the second channel (e.g., the second set of pins). In examples in which the memory system 110 determines that the data communicated via the first channel is different from the data communicated via the second channel, at 515, the memory system 110 may indicate the difference (e.g., mismatch) to the host system 105. Such comparison techniques are described in further detail elsewhere herein, including with reference to FIG. 4, for example.

In some examples, at 520, the host system 105 may perform error monitoring to determine if there is a fault in one or both of the first set of pins and the second set of pins. For example, the host system 105 may monitor for the indication of the mismatch from the memory system 110, or may determine whether an error has occurred in data communicated via the first channel and/or the second channel. In examples in which the host system 105 detects a fault (e.g., based on satisfaction of a threshold error condition, such as detecting a threshold quantity of errors, detecting errors for a threshold duration, detecting a short circuit associated with the first set of pins, and/or detecting an open circuit associated with the first set of pins), at 525, the host system 105 may output an indication of one or more errors in the communicated data to the memory system 110.

At 530, in response to detecting a fault (e.g., based on detecting the threshold quantity of errors or detecting errors for the threshold duration), the host system 105 may indicate for the memory system 110 to switch from communicating the data via the first channel (e.g., via the first set of pins) to communicating the data via the second channel (e.g., via the second set of pins). For example, the host system 105 may adjust a value of a MR bit of the memory system 110 from a first value that indicates for the memory system 110 to communicate via the first set of pins to a second value that indicates for the memory system 110 to communicate via the second set of pins. Additionally, or alternatively, the host system 105 may adjust a value of the MR bit of the memory system 110 from a first value that indicates for the memory system 110 to communicate via both of the first set of pins and the second set of pins to a second value that indicates for the memory system 110 to communicate via the second set of pins.

In some examples, the indication of the one or more errors may be included in the indication for the memory system 110 to switch from the first set of pins to the second set of pins, or may be in a separate indication. The memory system 110 may receive the indication to switch from the first set of pins to the second set of pins based on receiving the indication (e.g., detecting the value of the MR bit).

At 535, the host system 105 and the memory system 110 may communicate data via the second channel in response to the host system 105 indicating for the memory system 110 to switch from the first set of pins to the second set of pins. The memory system 110 and the host system 105 may accordingly refrain from communicating via the first channel. In some examples (e.g., if the host system 105 detects a fault associated with the first PHY), the memory system 110 and the host system 105 may communicate via a third channel between the second set of pins and a second PHY of the host system 105. In such examples, the indication for the memory system 110 to switch from the first set of pins to the second set of pins may include an indication that the host system 105 may switch from the first PHY to the second PHY.

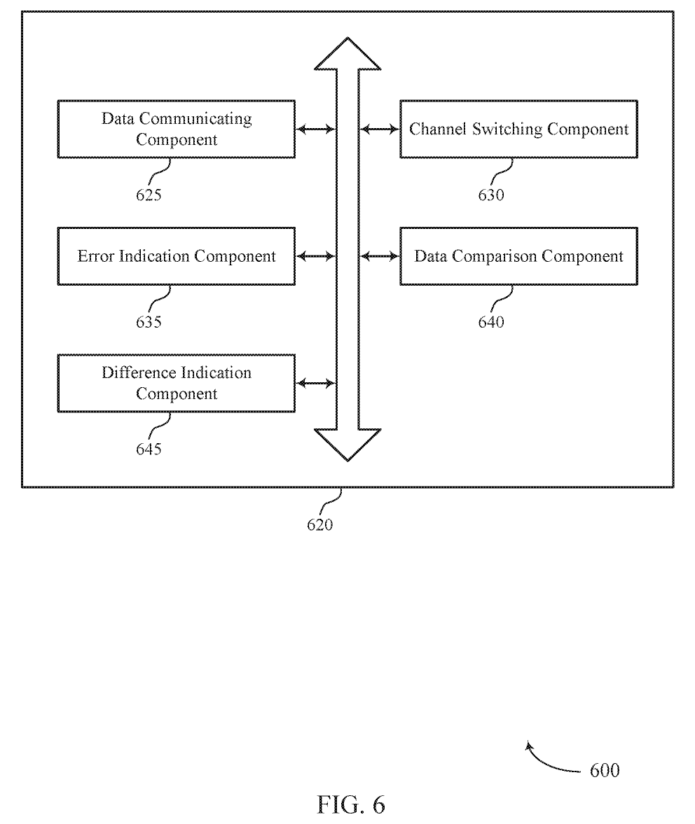

FIG. 6 shows a block diagram 600 of a memory system 620 that supports sub-channel switching using redundant pins in accordance with examples as disclosed herein. The memory system 620 may be an example of aspects of a memory system as described with reference to FIGS. 1 through 5. The memory system 620, or various components thereof, may be an example of means for performing various aspects of sub-channel switching using redundant pins as described herein. For example, the memory system 620 may include a data communicating component 625, a channel switching component 630, an error indication component 635, a data comparison component 640, a difference indication component 645, or any combination thereof. Each of these components, or components of subcomponents thereof (e.g., one or more processors, one or more memories), may communicate, directly or indirectly, with one another (e.g., via one or more buses).

The data communicating component 625 may be configured as or otherwise support a means for communicating data via a first channel between a host system and a first set of pins at the memory system. The channel switching component 630 may be configured as or otherwise support a means for receiving an indication to switch from communicating the data via the first channel to communicating the data via a second channel between the host system and a second set of pins at the memory system. In some examples, the data communicating component 625 may be configured as or otherwise support a means for communicating the data via the second channel based at least in part on the indication.

In some examples, to support receiving the indication to switch from communicating the data via the first channel to communicating the data via the second channel, the channel switching component 630 may be configured as or otherwise support a means for detecting a value of a mode register that indicates for the memory system to switch from communicating the data via the first channel to communicating the data via the second channel.

In some examples, the error indication component 635 may be configured as or otherwise support a means for receiving, via the indication or a second indication, information that indicates one or more errors within the data communicated via the first channel satisfy a threshold error condition, where the indication to switch from communicating the data via the first channel to communicating the data via the second channel is based at least in part on the information.

In some examples, the threshold error condition includes the one or more errors within the data satisfying a threshold quantity of errors, a short circuit associated with the first set of pins, an open circuit associated with the first set of pins, or any combination thereof.

In some examples, communicating the data via the first channel includes communicating the data via the first channel between the first set of pins and a first physical interface of the host system. In some examples, communicating the data via the second channel includes communicating the data via the second channel between the second set of pins and the first physical interface of the host system.

In some examples, communicating the data via the first channel includes communicating the data via the first channel between the first set of pins and a first physical interface of the host system. In some examples, communicating the data via the second channel includes communicating the data via the second channel between the second set of pins and a second physical interface of the host system. In some examples, the indication to switch to the second channel further indicates that a physical interface at the host system switches to the second physical interface.

In some examples, the data communicating component 625 may be configured as or otherwise support a means for communicating, in accordance with an interleaving pattern, the data via both of the first channel using the first set of pins and the second channel using the second set of pins, where the first channel and the second channel are coupled with a first physical interface of the host system. In some examples, the data comparison component 640 may be configured as or otherwise support a means for comparing the data communicated via the first channel and the data communicated via the second channel. In some examples, the difference indication component 645 may be configured as or otherwise support a means for outputting a second indication of a difference between the data communicated via the first channel and the data communicated via the second channel based at least in part on the comparison, where receiving the indication to switch from communicating the data via the first channel to communicating the data via the second channel is based at least in part on the second indication of the difference between the data communicated via the first channel and the data communicated via the second channel.

In some examples, communicating the data via the second channel after receiving the indication to switch from communicating the data via the first channel to communicating the data via the second channel includes communicating the data via the second channel between the second set of pins and a second physical interface of the host system. In some examples, the indication to switch to the second channel further indicates that a physical interface at the host system switches from the first physical interface to the second physical interface.

In some examples, the data communicating component 625 may be configured as or otherwise support a means for refraining from communicating the data via the first channel based at least in part on the indication.

In some examples, the first set of pins and the second set of pins include command address pins, data pins, or both.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

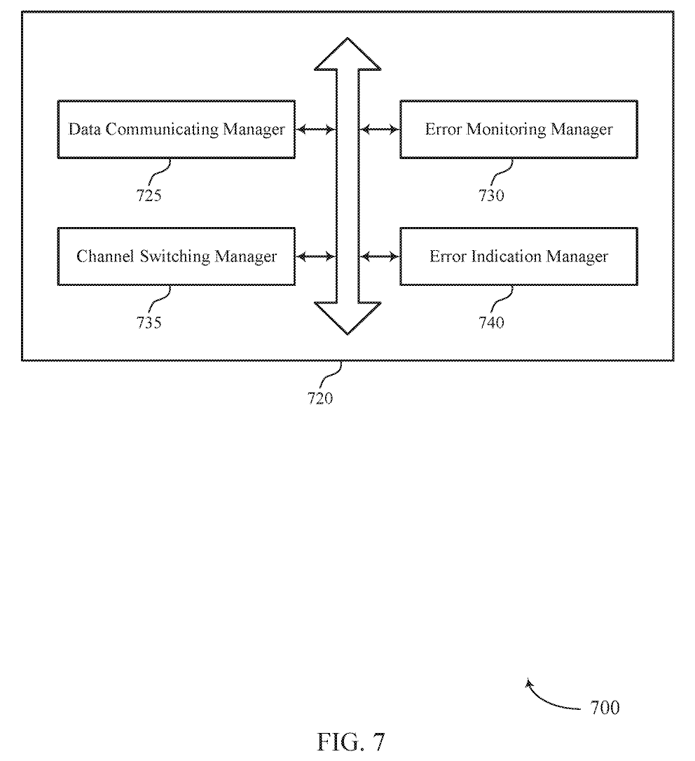

FIG. 7 shows a block diagram 700 of a host system 720 that supports sub-channel switching using redundant pins in accordance with examples as disclosed herein. The host system 720 may be an example of aspects of a host system as described with reference to FIGS. 1 through 5. The host system 720, or various components thereof, may be an example of means for performing various aspects of sub-channel switching using redundant pins as described herein. For example, the host system 720 may include a data communicating manager 725, an error monitoring manager 730, a channel switching manager 735, an error indication manager 740, or any combination thereof. Each of these components, or components of subcomponents thereof (e.g., one or more processors, one or more memories), may communicate, directly or indirectly, with one another (e.g., via one or more buses).

The data communicating manager 725 may be configured as or otherwise support a means for communicating data via a first channel between the host system and a first set of pins at a memory system. The error monitoring manager 730 may be configured as or otherwise support a means for monitoring for one or more errors within the data communicated via the first channel. In some examples, the data communicating manager 725 may be configured as or otherwise support a means for communicating the data with the memory system via a second channel between the host system and a second set of pins at the memory system based at least in part on the one or more errors satisfying a threshold error condition.

In some examples, the channel switching manager 735 may be configured as or otherwise support a means for outputting, to the memory system, an indication to switch from communicating the data via the first channel to communicating the data via the second channel based at least in part on the one or more errors satisfying the threshold error condition.

In some examples, to support outputting the indication for the memory system to switch from communicating the data via the first channel to communicating the data via the second channel, the channel switching manager 735 may be configured as or otherwise support a means for setting a mode register to a value that indicates for the memory system to switch from communicating the data via the first channel to communicating the data via the second channel.

In some examples, the error indication manager 740 may be configured as or otherwise support a means for outputting, via the indication or a second indication, information that indicates that the one or more errors satisfy the threshold error condition.

In some examples, communicating the data via the first channel includes communicating the data via the first channel between the first set of pins of the memory system and a first physical interface of the host system. In some examples, communicating the data via the second channel includes communicating the data via the second channel between the second set of pins of the memory system and the first physical interface of the host system.

In some examples, communicating the data via the first channel includes communicating the data via the first channel between the first set of pins of the memory system and a first physical interface of the host system. In some examples, communicating the data via the second channel includes communicating the data via the second channel between the second set of pins of the memory system and a second physical interface of the host system.

In some examples, the data communicating manager 725 may be configured as or otherwise support a means for communicating, in accordance with an interleaving pattern, the data via both of the first channel between the first set of pins of the memory system and the host system and the second channel between the second set of pins of the memory system and the host system, where the first channel and the second channel are coupled with a first physical interface of the host system. In some examples, the error indication manager 740 may be configured as or otherwise support a means for receiving an indication of a difference between the data communicated via the first channel and the data communicated via the second channel, where the threshold error condition includes a threshold quantity of differences between the data communicated via the first channel and the data communicated via the second channel.

In some examples, communicating the data via the second channel includes communicating the data via the second channel between the second set of pins of the memory system and a second physical interface of the host system.

In some examples, the data communicating manager 725 may be configured as or otherwise support a means for refraining from communicating the data via the first channel in based at least in part on the one or more errors satisfying the threshold error condition.

In some examples, the threshold error condition includes the one or more errors satisfying a threshold quantity of errors, detection of a short circuit associated with the first set of pins, detection of an open circuit associated with the first set of pins, or any combination thereof.

In some examples, the first set of pins and the second set of pins include command address pins, data pins, or both.

In some examples, the described functionality of the host system 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 720, or various components thereof, may be implemented at least in part by instructions (e.g., stored in memory, non-transitory computer-readable medium) executable by such at least one processor.

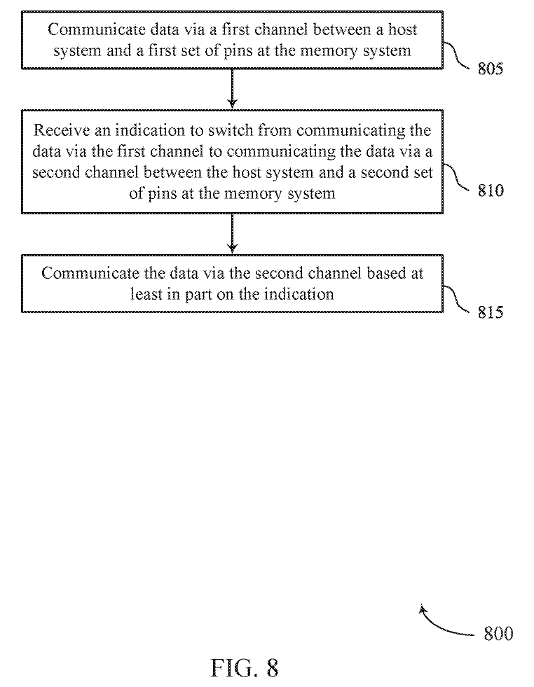

FIG. 8 shows a flowchart illustrating a method 800 that supports sub-channel switching using redundant pins in accordance with examples as disclosed herein. The operations of method 800 may be implemented by a memory system or its components as described herein. For example, the operations of method 800 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 805, the method may include communicating data via a first channel between a host system and a first set of pins at the memory system. In some examples, aspects of the operations of 805 may be performed by a data communicating component 625 as described with reference to FIG. 6.

At 810, the method may include receiving an indication to switch from communicating the data via the first channel to communicating the data via a second channel between the host system and a second set of pins at the memory system. In some examples, aspects of the operations of 810 may be performed by a channel switching component 630 as described with reference to FIG. 6.

At 815, the method may include communicating the data via the second channel based at least in part on the indication. In some examples, aspects of the operations of 815 may be performed by a data communicating component 625 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for communicating data via a first channel between a host system and a first set of pins at the memory system; receiving an indication to switch from communicating the data via the first channel to communicating the data via a second channel between the host system and a second set of pins at the memory system; and communicating the data via the second channel based at least in part on the indication.

Aspect 2: The method, apparatus, or non-transitory computer-readable medium of aspect 1, where receiving the indication to switch from communicating the data via the first channel to communicating the data via the second channel includes operations, features, circuitry, logic, means, or instructions, or any combination thereof for detecting a value of a mode register that indicates for the memory system to switch from communicating the data via the first channel to communicating the data via the second channel.

Aspect 3: The method, apparatus, or non-transitory computer-readable medium of any of aspects 1 through 2, further including operations, features, circuitry, logic, means, or instructions, or any combination thereof for receiving, via the indication or a second indication, information that indicates one or more errors within the data communicated via the first channel satisfy a threshold error condition, where the indication to switch from communicating the data via the first channel to communicating the data via the second channel is based at least in part on the information.

Aspect 4: The method, apparatus, or non-transitory computer-readable medium of aspect 3, where the threshold error condition includes the one or more errors within the data satisfying a threshold quantity of errors, a short circuit associated with the first set of pins, an open circuit associated with the first set of pins, or any combination thereof.

Aspect 5: The method, apparatus, or non-transitory computer-readable medium of any of aspects 1 through 4, where communicating the data via the first channel includes communicating the data via the first channel between the first set of pins and a first physical interface of the host system and communicating the data via the second channel includes communicating the data via the second channel between the second set of pins and the first physical interface of the host system.

Aspect 6: The method, apparatus, or non-transitory computer-readable medium of any of aspects 1 through 5, where communicating the data via the first channel includes communicating the data via the first channel between the first set of pins and a first physical interface of the host system; communicating the data via the second channel includes communicating the data via the second channel between the second set of pins and a second physical interface of the host system; and the indication to switch to the second channel further indicates that a physical interface at the host system switches to the second physical interface.

Aspect 7: The method, apparatus, or non-transitory computer-readable medium of any of aspects 1 through 6, further including operations, features, circuitry, logic, means, or instructions, or any combination thereof for communicating, in accordance with an interleaving pattern, the data via both of the first channel using the first set of pins and the second channel using the second set of pins, where the first channel and the second channel are coupled with a first physical interface of the host system; comparing the data communicated via the first channel and the data communicated via the second channel; and outputting a second indication of a difference between the data communicated via the first channel and the data communicated via the second channel based at least in part on the comparison, where receiving the indication to switch from communicating the data via the first channel to communicating the data via the second channel is based at least in part on the second indication of the difference between the data communicated via the first channel and the data communicated via the second channel.

Aspect 8: The method, apparatus, or non-transitory computer-readable medium of aspect 7, where communicating the data via the second channel after receiving the indication to switch from communicating the data via the first channel to communicating the data via the second channel includes communicating the data via the second channel between the second set of pins and a second physical interface of the host system and the indication to switch to the second channel further indicates that a physical interface at the host system switches from the first physical interface to the second physical interface.

Aspect 9: The method, apparatus, or non-transitory computer-readable medium of any of aspects 1 through 8, further including operations, features, circuitry, logic, means, or instructions, or any combination thereof for refraining from communicating the data via the first channel based at least in part on the indication.

Aspect 10: The method, apparatus, or non-transitory computer-readable medium of any of aspects 1 through 9, where the first set of pins and the second set of pins include command address pins, data pins, or both.

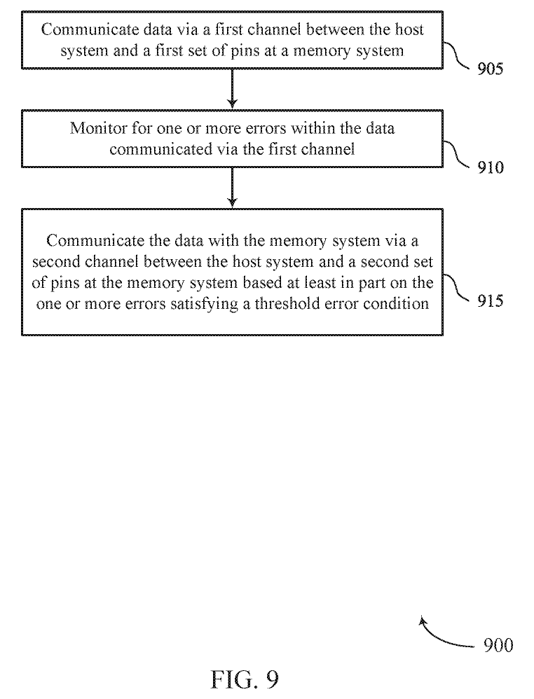

FIG. 9 shows a flowchart illustrating a method 900 that supports sub-channel switching using redundant pins in accordance with examples as disclosed herein. The operations of method 900 may be implemented by a host system or its components as described herein. For example, the operations of method 900 may be performed by a host system as described with reference to FIGS. 1 through 5 and 7. In some examples, a host system may execute a set of instructions to control the functional elements of the device to perform the described functions. Additionally, or alternatively, the host system may perform aspects of the described functions using special-purpose hardware.

At 905, the method may include communicating data via a first channel between the host system and a first set of pins at a memory system. In some examples, aspects of the operations of 905 may be performed by a data communicating manager 725 as described with reference to FIG. 7.

At 910, the method may include monitoring for one or more errors within the data communicated via the first channel. In some examples, aspects of the operations of 910 may be performed by an error monitoring manager 730 as described with reference to FIG. 7.

At 915, the method may include communicating the data with the memory system via a second channel between the host system and a second set of pins at the memory system based at least in part on the one or more errors satisfying a threshold error condition. In some examples, aspects of the operations of 915 may be performed by a data communicating manager 725 as described with reference to FIG. 7.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for communicating data via a first channel between the host system and a first set of pins at a memory system; monitoring for one or more errors within the data communicated via the first channel; and communicating the data with the memory system via a second channel between the host system and a second set of pins at the memory system based at least in part on the one or more errors satisfying a threshold error condition.

Aspect 12: The method, apparatus, or non-transitory computer-readable medium of aspect 11, further including operations, features, circuitry, logic, means, or instructions, or any combination thereof for outputting, to the memory system, an indication to switch from communicating the data via the first channel to communicating the data via the second channel based at least in part on the one or more errors satisfying the threshold error condition.

Aspect 13: The method, apparatus, or non-transitory computer-readable medium of aspect 12, where outputting the indication for the memory system to switch from communicating the data via the first channel to communicating the data via the second channel includes operations, features, circuitry, logic, means, or instructions, or any combination thereof for setting a mode register to a value that indicates for the memory system to switch from communicating the data via the first channel to communicating the data via the second channel.

Aspect 14: The method, apparatus, or non-transitory computer-readable medium of any of aspects 12 through 13, further including operations, features, circuitry, logic, means, or instructions, or any combination thereof for outputting, via the indication or a second indication, information that indicates that the one or more errors satisfy the threshold error condition.

Aspect 15: The method, apparatus, or non-transitory computer-readable medium of any of aspects 11 through 14, where communicating the data via the first channel includes communicating the data via the first channel between the first set of pins of the memory system and a first physical interface of the host system and communicating the data via the second channel includes communicating the data via the second channel between the second set of pins of the memory system and the first physical interface of the host system.

Aspect 16: The method, apparatus, or non-transitory computer-readable medium of any of aspects 11 through 15, where communicating the data via the first channel includes communicating the data via the first channel between the first set of pins of the memory system and a first physical interface of the host system and communicating the data via the second channel includes communicating the data via the second channel between the second set of pins of the memory system and a second physical interface of the host system.

Aspect 17: The method, apparatus, or non-transitory computer-readable medium of any of aspects 11 through 16, further including operations, features, circuitry, logic, means, or instructions, or any combination thereof for communicating, in accordance with an interleaving pattern, the data via both of the first channel between the first set of pins of the memory system and the host system and the second channel between the second set of pins of the memory system and the host system, where the first channel and the second channel are coupled with a first physical interface of the host system and receiving an indication of a difference between the data communicated via the first channel and the data communicated via the second channel, where the threshold error condition includes a threshold quantity of differences between the data communicated via the first channel and the data communicated via the second channel.

Aspect 18: The method, apparatus, or non-transitory computer-readable medium of aspect 17, where communicating the data via the second channel includes communicating the data via the second channel between the second set of pins of the memory system and a second physical interface of the host system.

Aspect 19: The method, apparatus, or non-transitory computer-readable medium of any of aspects 11 through 18, further including operations, features, circuitry, logic, means, or instructions, or any combination thereof for refraining from communicating the data via the first channel in based at least in part on the one or more errors satisfying the threshold error condition.

Aspect 20: The method, apparatus, or non-transitory computer-readable medium of any of aspects 11 through 19, where the threshold error condition includes the one or more errors satisfying a threshold quantity of errors, detection of a short circuit associated with the first set of pins, detection of an open circuit associated with the first set of pins, or any combination thereof.

Aspect 21: The method, apparatus, or non-transitory computer-readable medium of any of aspects 11 through 20, where the first set of pins and the second set of pins include command address pins, data pins, or both.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
communicate data via a first channel between a host system and a first set of pins at the memory system;
receive an indication to switch from communicating the data via the first channel to communicating the data via a second channel between the host system and a second set of pins at the memory system; and
communicate the data via the second channel based at least in part on the indication.

2. The memory system of claim 1, wherein, to receive the indication to switch from communicating the data via the first channel to communicating the data via the second channel, the processing circuitry is configured to cause the memory system to:
detect a value of a mode register that indicates for the memory system to switch from communicating the data via the first channel to communicating the data via the second channel.

3. The memory system of claim 1, wherein the processing circuitry is configured to cause the memory system to:
receive, via the indication or a second indication, information that indicates one or more errors within the data communicated via the first channel satisfy a threshold error condition, wherein the indication to switch from communicating the data via the first channel to communicating the data via the second channel is based at least in part on the information.

4. The memory system of claim 3, wherein the threshold error condition comprises the one or more errors within the data satisfying a threshold quantity of errors, a short circuit associated with the first set of pins, an open circuit associated with the first set of pins, or any combination thereof.

5. The memory system of claim 1, wherein, to communicate the data via the first channel, the processing circuitry is configured to cause the memory system to:
communicate the data via the first channel between the first set of pins and a first physical interface of the host system, and wherein to communicate the data via the second channel, the processing circuitry is configured to cause the memory system to:
communicate the data via the second channel between the second set of pins and the first physical interface of the host system.

6. The memory system of claim 1, wherein, to communicate the data via the first channel, the processing circuitry is configured to cause the memory system to:
communicate the data via the first channel between the first set of pins and a first physical interface of the host system, and wherein, to communicate the data via the second channel, the processing circuitry is configured to cause the memory system to:
communicate the data via the second channel between the second set of pins and a second physical interface of the host system, and wherein the indication to switch to the second channel further indicates that a physical interface at the host system switches to the second physical interface.

7. The memory system of claim 1, wherein the processing circuitry is configured to cause the memory system to:
communicate, in accordance with an interleaving pattern, the data via both of the first channel using the first set of pins and the second channel using the second set of pins, wherein the first channel and the second channel are coupled with a first physical interface of the host system;
compare the data communicated via the first channel and the data communicated via the second channel; and
output a second indication of a difference between the data communicated via the first channel and the data communicated via the second channel based at least in part on the comparison, wherein receiving the indication to switch from communicating the data via the first channel to communicating the data via the second channel is based at least in part on the second indication of the difference between the data communicated via the first channel and the data communicated via the second channel.

8. The memory system of claim 7, wherein, to communicate the data via the second channel after receiving the indication to switch from communicating the data via the first channel to communicating the data via the second channel, the processing circuitry is configured to:
communicate the data via the second channel between the second set of pins and a second physical interface of the host system, and wherein the indication to switch to the second channel further indicates that a physical interface at the host system switches from the first physical interface to the second physical interface.

9. The memory system of claim 1, wherein the processing circuitry is further configured to cause the memory system to:
refrain from communicating the data via the first channel based at least in part on the indication.

10. The memory system of claim 1, wherein the first set of pins and the second set of pins comprise command address pins, data pins, or both.

11. A host system, comprising:
one or more interfaces comprising one or more signal paths operable for communications with one or more memory systems; and
processing circuitry coupled with the one or more interfaces and configured to cause the host system to:
communicate data via a first channel between the host system and a first set of pins at a memory system;
monitor for one or more errors within the data communicated via the first channel; and
communicate the data with the memory system via a second channel between the host system and a second set of pins at the memory system based at least in part on the one or more errors satisfying a threshold error condition.

12. The host system of claim 11, wherein the processing circuitry is further configured to cause the host system to:
output, to the memory system, an indication to switch from communicating the data via the first channel to communicating the data via the second channel based at least in part on the one or more errors satisfying the threshold error condition.

13. The host system of claim 12, wherein, to output the indication for the memory system to switch from communicating the data via the first channel to communicating the data via the second channel, the processing circuitry is configured to cause the host system to:
set a mode register to a value that indicates for the memory system to switch from communicating the data via the first channel to communicating the data via the second channel.

14. The host system of claim 12, wherein the processing circuitry is further configured to cause the host system to:
output, via the indication or a second indication, information that indicates that the one or more errors satisfy the threshold error condition.

15. The host system of claim 11, wherein, to communicate the data via the first channel, the processing circuitry is configured to cause the host system to:
communicate the data via the first channel between the first set of pins of the memory system and a first physical interface of the host system, and wherein, to communicate the data via the second channel, the processing circuitry is configured to cause the host system to:
communicate the data via the second channel between the second set of pins of the memory system and the first physical interface of the host system.

16. The host system of claim 11, wherein, to communicate the data via the first channel, the processing circuitry is configured to cause the host system to:
communicate the data via the first channel between the first set of pins of the memory system and a first physical interface of the host system, and wherein, to communicate the data via the second channel, the processing circuitry is configured to cause the host system to:
communicate the data via the second channel between the second set of pins of the memory system and a second physical interface of the host system.

17. The host system of claim 11, wherein the processing circuitry is further configured to cause the host system to:
communicate, in accordance with an interleaving pattern, the data via both of the first channel between the first set of pins of the memory system and the host system and the second channel between the second set of pins of the memory system and the host system, wherein the first channel and the second channel are coupled with a first physical interface of the host system; and
receive an indication of a difference between the data communicated via the first channel and the data communicated via the second channel, wherein the threshold error condition comprises a threshold quantity of differences between the data communicated via the first channel and the data communicated via the second channel.

18. The host system of claim 17, wherein, to communicate the data via the second channel, the processing circuitry is configured to cause the host system to:
communicate the data via the second channel between the second set of pins of the memory system and a second physical interface of the host system.

19. The host system of claim 11, wherein the processing circuitry is further configured to cause the host system to:
refrain from communicating the data via the first channel in based at least in part on the one or more errors satisfying the threshold error condition.

20. The host system of claim 11, wherein the threshold error condition comprises the one or more errors satisfying a threshold quantity of errors, detection of a short circuit associated with the first set of pins, detection of an open circuit associated with the first set of pins, or any combination thereof.

21. The host system of claim 11, wherein the first set of pins and the second set of pins comprise command address pins, data pins, or both.

22. A method by a memory system, comprising:
communicating data via a first channel between a host system and a first set of pins at the memory system;
receiving an indication to switch from communicating the data via the first channel to communicating the data via a second channel between the host system and a second set of pins at the memory system; and
communicating the data via the second channel based at least in part on the indication.
